(19) United States
(12) Patent Application Publication
(10) Pub. No.: US 2010/0240230 A1
(43) Pub. Date: Sep. 23, 2010

(54) POWER PLUG

(76) Inventor: Ching Chuan Lee, Sindian City (TW)

Correspondence Address: SINORICA, LLC, 2275 Research Blvd., Suite 500, ROCKVILLE, MD, 20850, US

(21) Appl. No.: 12/406,011

(22) Filed: Mar. 17, 2009

(51) Int. Cl. H01R 11/30

(52) U.S. Cl. 439/38

(57) ABSTRACT

The present invention relates to a power plug, comprises: a magnetic conductive ring; a grounding insulation supporting ring; a grounding ring connection seat, a grounding connection sheet is extended from one end of the grounding ring connection seat; a power insulation supporting ring; a power ring connection seat, a power connection sheet is extended from one end of the power ring connection seat; an insulation supporting ring; an identifying connection seat; an insulation retaining ring and a cable housing. The identifying connection seat and the power ring connection seat and the grounding ring connection seat are assembled in a manner of a ring being provided on other rings therefore a 360 degree nondirectional power plug is obtained.

### BACKGROUND OF THE INVENTION

1. Field of the Invention

The present invention relates to a power plug, more particularly to a 360 degree nondirectional power plug having an identifying connection seat and a power ring connection seat and a grounding ring connection seat being assembled in a manner of a ring being provided on other rings.

2. Description of Related Art

A portable electronic device, e.g. a notebook computer, often obtains DC power via a power adapter. The connection between the power adapter and the notebook computer is via a combination of a power plug and a power socket therefore the electrical connection between the notebook computer and the power adapter is firm and stable. For achieving a stable electrical connection, in the combination of power plug and power socket, the power socket often has a deep or long accommodating space for receiving the power plug.

The structure of the described power socket is often provided with a plurality of resilient solid contact points for receiving the power plug, but the arrangement of the resilient solid contact points can be only arranged to certain arrangements, such as a matrix, so the arrangement of the resilient solid contact points has directionality, thus a plugging operation is not convenient.

### SUMMARY OF THE INVENTION

One object of the present invention is to provide a power plug having an identifying connection seat and a power ring connection seat and a grounding ring connection seat; the identifying connection seat and the power ring connection seat and the grounding ring connection seat are assembled in a manner of a ring being provided on other rings therefore a 360 degree nondirectional power plug is obtained.

Another object of the present invention is to provide a power plug having an identifying connection seat and a power ring connection seat and a grounding ring connection seat; the identifying connection seat and the power ring connection seat and the grounding ring connection seat are all resilient and retractable so that a contact means is able to be changed from a point-to-point contact to a plane-to-plane contact, therefore current that allows to pass through the power plug and loading capacity are increased.

For achieving the objects mentioned above, the present invention provides a power plug, comprises: a magnetic conductive ring, the magnetic conductive ring is hollow; a grounding insulation supporting ring, the grounding insulation supporting ring is hollow and is received and retained in the magnetic conductive ring; a grounding ring connection seat, the grounding ring connection seat is hollow and is received in the grounding insulation supporting ring and the magnetic conductive ring, a grounding connection sheet is extended from one end of the grounding ring connection seat and the other end thereof is provided with at least one grounding ring, and spaces between the grounding rings are resilient and retractable; a power insulation supporting ring, a hollow round column is protruded from one end of the power insulation supporting ring, the hollow round column is received in the grounding ring connection seat; a power ring connection seat, the power ring connection seat is received in the hollow round column of the power insulation supporting ring, a power connection sheet is extended from one end of the power ring connection seat, the power connection sheet is disposed opposite to the grounding connection sheet, the other end of the power ring connection seat is provided with at least one power ring, spaces between the power rings are resilient and retractable; an insulation supporting ring, a hollow round column is protruded from one end of the insulation supporting ring and is received in the hollow round column of the power ring connection seat; an identifying connection seat, the identifying connection seat is provided in the hollow round column of the insulation supporting ring; an insulation retaining ring, the insulation retaining ring has a round hole and two lug sections, the round hole is served to let the identifying connection seat pass through, the two lug sections are served to support the grounding connection sheet and the power connection sheet; and a cable housing, the cable housing has an opening section and a shrinking section whose diameter is gradually shrunk, the opening section is served to receive the insulation retaining ring, the shrinking section is served to receive a cable, a plurality of conductive wires of the cable are respectively connected to the grounding connection sheet and the power connection sheet.

### BRIEF DESCRIPTION OF THE DRAWINGS

FIG. 1 is a schematic exploded view of a power plug of one preferred embodiment of the present invention;

FIG. 2 is a cross sectional view of a part of a power plug of one preferred embodiment of the present invention, after being assembled;

FIG. 3 is a schematic view illustrating a power plug of one preferred embodiment of the present invention being connected to a cable;

FIG. 4 is a schematic view illustrating a power plug of one preferred embodiment being further provided with a light conductive sleeve;

FIG. 5 is a schematic view illustrating an assembled power plug of one preferred embodiment of the present invention.

### DETAILED DESCRIPTION OF THE PREFERRED EMBODIMENT

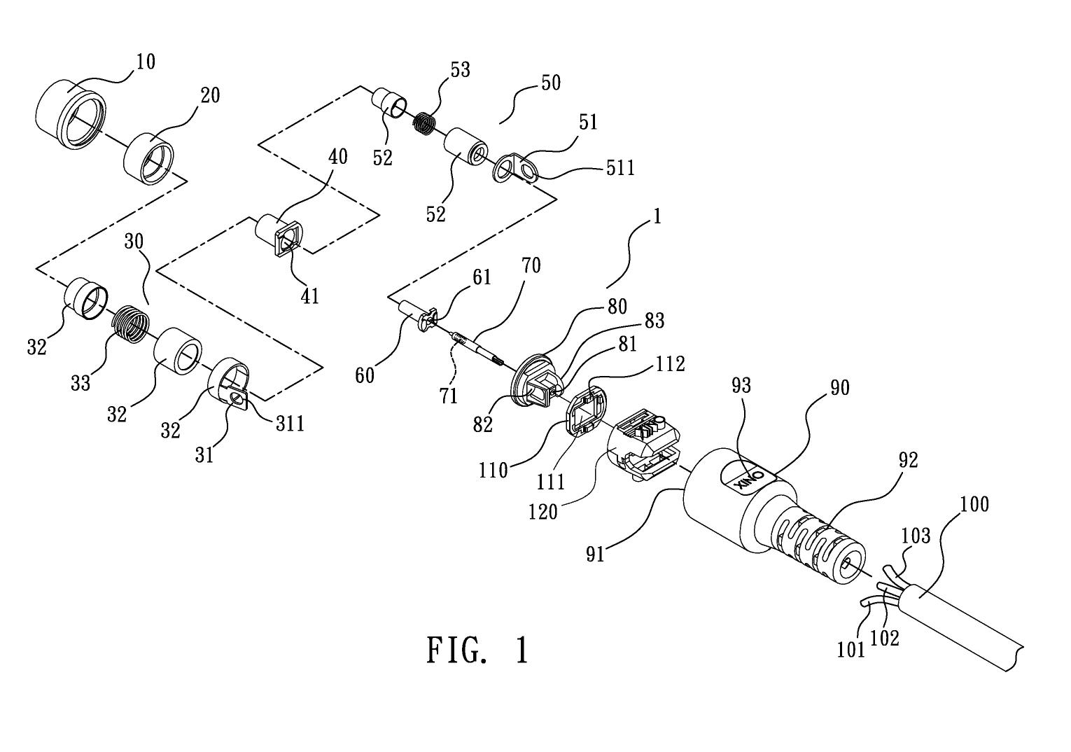

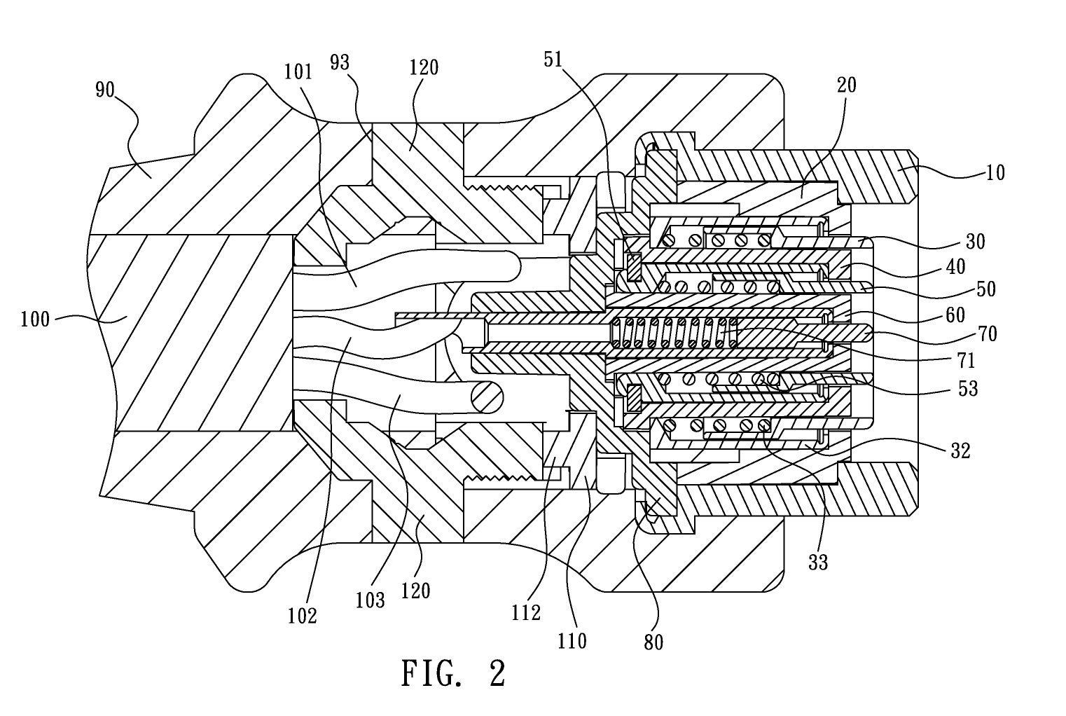

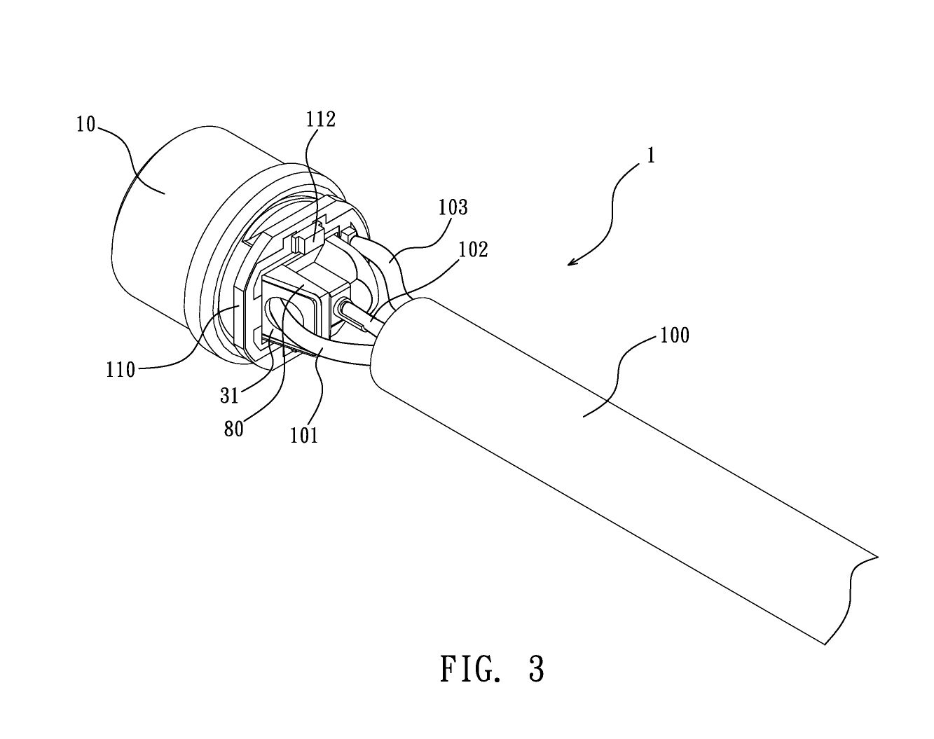

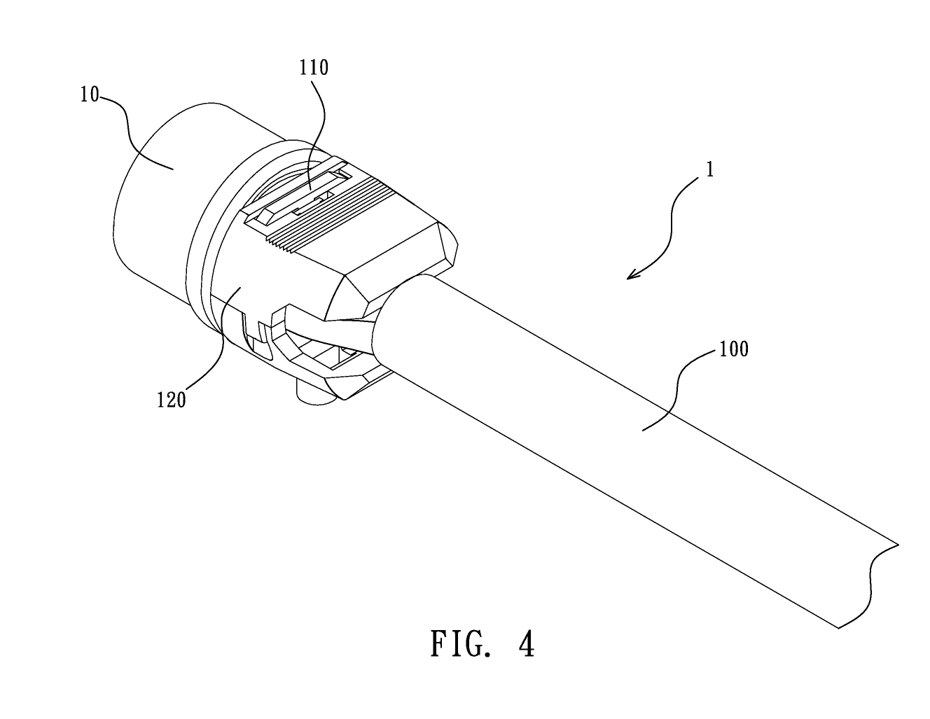

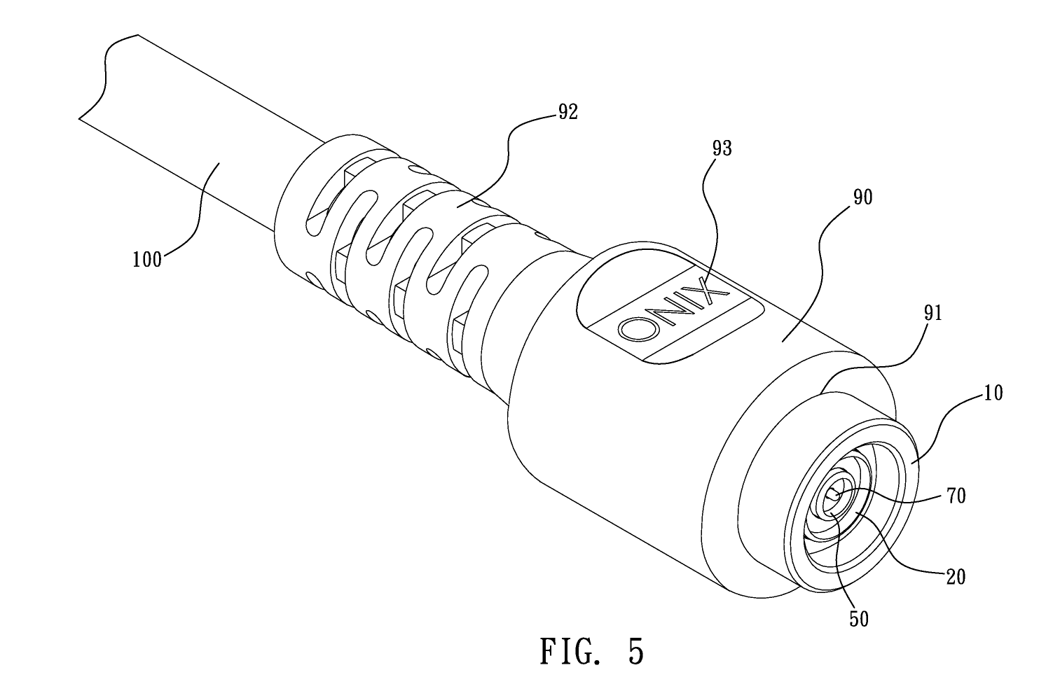

Referring to FIG. 1 to FIG. 5, in which FIG. 1 is a schematic exploded view of a power plug of one preferred embodiment of the present invention; FIG. 2 is a cross sectional view of a part of a power plug of one preferred embodiment of the present invention, after being assembled; FIG. 3 is a schematic view illustrating a power plug of one preferred embodiment of the present invention being connected to a cable; FIG. 4 is a schematic view illustrating a power plug of one preferred embodiment being further provided with a light conductive sleeve; FIG. 5 is a schematic view illustrating an assembled power plug of one preferred embodiment of the present invention.

As shown in figures, the power plug 1 provided by the present invention is able to be adopted in a portable electronic device, e.g. but not limited to a notebook computer, comprises: a magnetic conductive ring 10; a grounding insulation supporting ring 20; a grounding ring connection seat 30; a power insulation supporting ring 40; a power ring connection seat 50; an insulation supporting ring 60; an identifying connection seat 70; an insulation retaining ring 80 and a cable housing 90.

The magnetic conductive ring 10 is hollow and made of metal materials for providing a magnetic conducting function.

The grounding insulation supporting ring 20 is hollow and is received and retained in the magnetic conductive ring 10, and is made of insulation materials, e.g. but not limited to, plastic materials.

The grounding ring connection seat 30 is hollow and is received in the grounding insulation supporting ring 20 and the magnetic conductive ring 10, a grounding connection sheet 31 is extended from one end of the grounding ring connection seat 30 and the other end thereof is provided with at least one grounding ring 32, and spaces between the grounding rings 32 are retractable. In this embodiment, three grounding rings 32 are adopted for illustration and not served as a limitation. A first spring 33 is provided in an inner space of the grounding rings 32, therefore spaces between the grounding rings 32 are retractable. A wire connection hole 311 is further provided on the grounding connection sheet 31 for being connected to a conductive wire.

A hollow round column 41 is protruded from one end of the power insulation supporting ring 40, the hollow round column 41 is received in the grounding ring connection seat 30.

The power ring connection seat 50 is received in the hollow round column 41 of the power insulation supporting ring 40, a power connection sheet 51 is extended from one end of the power ring connection seat 50 and the power connection sheet 51 is provided opposite to the grounding connection sheet 31, the other end of the power ring connection seat 50 is provided with at least one power ring 52, and spaces between the power rings 52 are retractable. In this embodiment, two power rings 52 are adopted for illustration and not served as a limitation. A second spring 53 is provided in an inner space of the power rings 52, therefore spaces between the power rings 52 are retractable. A wire connection hole 511 is further provided on the power connection sheet 51 for being connected to a conductive wire.

A hollow round column 61 is protruded from one end of the insulation supporting ring 60 and is received in the hollow round column 51 of the power ring connection seat 50.

The identifying connection seat 70 is received in the hollow round column 61 of the insulation supporting ring 60 and a third spring 71 is provided in an inner space of the identifying connection seat 70, therefore the identifying connection seat 70 is retractable.

The insulation retaining ring 80 is provided with a round hole 80 and two lug sections 82, 83, the round hole 81 is served to let the identifying connection seat 70 pass through, the two lug sections 82, 83 are served to receive and support the grounding connection sheet 31 and the power connection sheet 51.

The cable housing 90 is provided with an opening section 91 and a shrinking section 92 whose diameter is gradually shrunk, the opening section 91 is served to receive the insulation retaining ring 80, the shrinking section 92 is served to receive a cable 100, a plurality of conductive wires 101, 102 and 103 of the cable 100 are respectively connected to the grounding connection sheet 31, the power connection sheet 51 and the identifying connection seat 70. In this embodiment, the three conductive wires 101, 102 and 103 are adopted for illustration and not served as a limitation.

A printed circuit board 110 is further provided on the power plug 1 provided by the present invention, the printed circuit board 110 has an opening 111 and is connected to an outer end of the insulation retaining ring 80.

An indicating lamp 112 is further provided on the power plug 1 provided by the present invention, the indicating lamp 112 is provided on the printed circuit board 110 and coupled to the grounding connection sheet 31 and the power connection sheet 51 for providing a power indication or a backlight indication. The indicating lamp 112 can be, but not limited to, a LED.

A light conductive sleeve 120 is further provided on the power plug 1 provided by the present invention, e.g. but not limited to a transparent member, and the light conductive sleeve 120 is provided on the printed circuit board 110 so light illuminated from the indicating lamp 112 is more unified.

One end of the opening section 91 of the cable housing 90 has a trademark, a pattern or texts 93, in this embodiment a trademark “XINO” is adopted for illustration and not served as a limitation; light illuminated from the indicating lamp 112 is capable of passing through the trademark, the pattern or the texts 93.

Referring to FIG. 2 to FIG. 5, when being assembled, the grounding ring connection seat 30 is firstly received in the grounding insulation supporting ring 20, then the grounding insulation supporting ring 20 is received in the magnetic conductive ring 10; the power insulation supporting ring 40 is received in the grounding ring connection seat 30; the power ring connection seat 50 is received in the power insulation supporting ring 40 so the power connection sheet 51 is disposed opposite to the grounding connection sheet 31; then the insulation supporting ring 60 is received in the power ring connection seat 50; the identifying connection seat 70 is received in the insulation supporting ring 60; then the insulation retaining ring 80 is received in the identifying connection seat 70 and between the power connection sheet 51 and the grounding connection sheet 31, and a rear end of the magnetic conductive ring 10 is fastened on the grounding insulation supporting ring 20 via a means of riveting; then the printed circuit board 110 is provided on the insulation retaining ring 80; the conductive wires 101, 102 and 103 of the cable 100 are respectively connected to the printed circuit board 110; then the light conductive sleeve 120 is sleeved on the cable 100; the cable housing 90 is provided on the light conductive sleeve 120 and the indicating lamp 112 is disposed aiming to the trademark, the pattern or the texts 93; an assembling operation of the power plug 1 provided by the present invention is therefore completed. When the power plug 1 is plugged in a magnetic power socket (not shown), the grounding connection sheet 31, the power connection sheet 51 and the identifying connection seat 70 are respectively in contact with a grounding connection sheet, a power connection sheet and an identifying connection probe of the magnetic power socket (not shown) for obtaining power, grounding and signal detection.

As mentioned above, the power plug provided by the present invention has an identifying connection seat, a power ring connection seat and a grounding ring connection seat; the identifying connection seat, the power ring connection seat and the grounding ring connection seat are assembled in a manner of a ring being provided on other rings, therefore a 360 degree nondirectional power plug is obtained; and the identifying connection seat, the power ring connection seat and the grounding ring connection seat are all resilient and retractable so that a contact means is changed from a point-to-point contact to a plane-to-plane contact, therefore advantages of increasing current and loading capacity are achieved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power plug, comprises:
a magnetic conductive ring, the magnetic conductive ring is hollow;
a grounding insulation supporting ring, the grounding insulation supporting ring is hollow and is received and retained in the magnetic conductive ring;
a grounding ring connection seat, the grounding ring connection seat is hollow and is received in the grounding insulation supporting ring and the magnetic conductive ring, a grounding connection sheet is extended from one end of the grounding ring connection seat and the other end thereof is provided with at least one grounding ring, and spaces between the grounding rings are resilient and retractable;
a power insulation supporting ring, a hollow round column is protruded from one end of the power insulation supporting ring, the hollow round column is received in the grounding ring connection seat;
a power ring connection seat, the power ring connection seat is received in the hollow round column of the power insulation supporting ring, a power connection sheet is extended from one end of the power ring connection seat, the power connection sheet is disposed opposite to the grounding connection sheet, the other end of the power ring connection seat is provided with at least one power ring, spaces between the power rings are resilient and retractable;
an insulation supporting ring, a hollow round column is protruded from one end of the insulation supporting ring and is received in the hollow round column of the power ring connection seat;
an identifying connection seat, the identifying connection seat is provided in the hollow round column of the insulation supporting ring;
an insulation retaining ring, the insulation retaining ring has a round hole and two lug sections, the round hole is served to let the identifying connection seat pass through, the two lug sections are served to support the grounding connection sheet and the power connection sheet; and
a cable housing, the cable housing has an opening section and a shrinking section whose diameter is gradually shrunk, the opening section is served to receive the insulation retaining ring, the shrinking section is served to receive a cable, a plurality of conductive wires of the cable are respectively connected to the grounding connection sheet and the power connection sheet.

2. The power plug as claimed in claim 1, wherein the magnetic conductive ring is made of metal materials; the grounding insulation supporting ring, the power insulation supporting ring, the insulation supporting ring, the insulation retaining ring and the cable housing are made of insulation materials.

3. The power plug as claimed in claim 1, wherein the grounding ring connection seat has three grounding rings, and a first spring is provided in an inner space of the grounding rings.

4. The power plug as claimed in claim 1, wherein the power ring connection seat has two power rings, and a second spring is provided in an inner space of the power rings.

5. The power plug as claimed in claim 1, wherein a third spring is provided in an inner space of the identifying connection seat.

6. The power plug as claimed in claim 1, further comprises a printed circuit board, the printed circuit board has an opening and is connected to an outer end of the insulation retaining ring.

7. The power plug as claimed in claim 6, further comprises an indicating lamp, the indicating lamp is provided on the printed circuit board and is coupled to the grounding connection sheet and the power connection sheet for providing a power indication or a backlight indication, and the indicating lamp is a LED.

8. The power plug as claimed in claim 7, further comprises a light conductive sleeve, the light conductive sleeve is provided on the printed circuit board so light illuminated from the indicating lamp is more unified.

9. The power plug as claimed in claim 8, wherein one end of the opening of the cable housing is provided with a trademark, a pattern or texts, and light illuminated from the indicating lamp is capable of passing through the trademark, the pattern or the texts.

10. The power plug as claimed in claim 1, wherein the grounding connection sheet and the power connection sheet are respectively provided with a wire connection hole for being connected to a conductive wire.
